(19) United States
(12) Patent Application Publication
(10) Pub. No.: US 2010/0289300 A1
(43) Pub. Date: Nov. 18, 2010

(54) STRUCTURE BODY FOR JOINING HOLLOW MEMBERS TOGETHER

(75) Inventor: Sadao Kokubo, Oyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHOWA DENKO K.K., Tokyo (JP)

(21) Appl. No.: 12/280,194

(22) PCT Filed: Feb. 20, 2007
(86) PCT No.: PCT/JP2007/053055

§ 371 Date: Jul. 30, 2010

(30) Foreign Application Priority Data
Feb. 21, 2006 (JP) 2006-043594

(51) Int. Cl. B62D 21/00; F16B 7/04; B60R 19/24; B23P 11/00

(52) U.S. Cl. 296/205; 403/204; 403/24; 293/155; 29/505

(57) ABSTRACT

A connection structure for hollow members, which is highly durable and can be produced at low cost, is provided. An insertion hole 12 is formed in at least one wall portion 11 of a pair of opposed wall portions 11 and 11 of a first hollow member 10. A sleeve 30 for preventing biting of a peripheral edge portion 12a of the insertion hole 12 into the outer peripheral surface of a second hollow member 20 is fixed to the first hollow member 10 with the sleeve 30 inserted in the insertion hole 12. A peripheral wall portion 22 of the second hollow member 20 inserted in the sleeve 30 is expanded with the second hollow member 20 inserted in the sleeve 30, so that the peripheral wall portion 22 of the inserted portion of the second hollow member 20 is pressed against and fixed to the inner peripheral surface of the sleeve 30.

### TECHNICAL FIELD

The present invention relates to a connection structure for hollow members used as, e.g., frames or bumpers for automobiles, and also relates to a method for connecting hollow members.

### BACKGROUND ART

Various methods for connecting two hollow members have been conventionally known (see, e.g., Patent Documents 1 to 6). One of the methods is shown in FIG. 26 (see Patent Document 1). The method will be explained as follows. An insertion hole 112 circular in cross-section is formed in each of a pair of opposed walls 111 and 111 of a metallic metal hollow member 100 rectangular in cross-section. The first hollow member 110 and the second hollow member 120 are connected by expanding the peripheral wall portion 122 of the second hollow member 120 by an electromagnetic forming method in a state in which the metallic second hollow member 120 circular in cross-section is inserted in both the insertion holes 112 and 112. “B3” denotes a connection structure produced by this method.

In FIG. 26, “L1” denotes a forming region of the second hollow member 120 located between both the opposed walls 111 and 111 of the first hollow member 110. “L2” denotes a forming region of the second hollow member 120 located outside one of the opposed walls 111 of the first hollow member 110. “144” denotes an electromagnetic coil of an electromagnetic forming device.

Patent Document 1: Japanese Unexamined Laid-open Patent Publication No. H09-166111 (FIG. 1)
Patent Document 2: Japanese Unexamined Laid-open Patent Publication No. H07-116751

### Patent Document 3: Japanese Unexamined Laid-open Patent Publication No. 2004-237818 (FIG. 1, FIG. 4, FIG. 5)

### Patent Document 4: Japanese Unexamined Laid-open Patent Publication No. 2005-262261 (FIG. 5, FIG. 9, FIG. 20)

### Patent Document 5: Japanese Unexamined Laid-open Patent Publication No. 2005-152920 (FIG. 1, FIG. 5, FIG. 9)

### Patent Document 6: Japanese Unexamined Laid-open Patent Publication No. 2002-86228 (FIG. 4)

### DISCLOSURE OF THE INVENTION

### Problems to be Solved by the Invention

The aforementioned conventional method has the following drawbacks. For example, in cases where the forming region L1 is larger than the forming region L2, increasing of the deformation volume in the deformation region L1 to attain a moderate deformation may cause ruptures of the second hollow member 120. To prevent such ruptures, the conventional method requires placing of a restraining mold (not shown) in the first hollow member 120. This requires the cost for purchasing such a restraining mold and the need for a placement operation of the restraining mold and a removal operation of the restraining mold after the electromagnetic forming, resulting in poor workability.

Also, as shown in FIG. 27, the peripheral edge portion 112a of the insertion hole 112 of the first hollow member 110 bites into the outer peripheral surface of the second hollow member 120, which easily causes stress concentration at the bitten portion 122a. Therefore, there was a drawback that the durability was poor.

Furthermore, there was another drawback that the extraction load was small due to the small contact area between the first hollow member 110 and the second hollow member 120.

The present invention was made in view of the aforementioned technological background, and aims to provide a connection structure for hollow members, which is high in durability and can be produced at low cost, a method for connecting hollow members, an automobile frame equipped with the aforementioned connection structure and the production method thereof, and an automobile bumper and the production method thereof.

Other objects and advantages of the present invention will be apparent from the following preferable embodiments.

### Means to Solve the Problems

The present invention provides the following means.

[1] A connection structure for connecting a first hollow member and a second hollow member,

wherein an insertion hole is formed in at least one of a pair of opposed wall portions of the first hollow member,

wherein a sleeve for preventing biting of a peripheral edge portion of the insertion hole into an outer peripheral surface of the second hollow member is fixed to the first hollow member with the sleeve inserted in the insertion hole, and

wherein a peripheral wall portion of an inserted portion of the second hollow member inserted in the sleeve is expanded with the second hollow member inserted in the sleeve, so that the peripheral wall portion of the inserted portion of the second hollow member is pressed against and fixed to an inner peripheral surface of the sleeve.

[2] The connection structure for hollow members as recited in the aforementioned Item 1,

wherein the sleeve is provided with a concave portion at an inner peripheral surface of the sleeve, and

wherein the peripheral wall portion of the inserted portion of the second hollow member is pressed against and fixed to the inner peripheral surface of the sleeve with the peripheral wall portion of the inserted portion engaged with the concave portion.

[3] The connection structure for hollow members as recited in the aforementioned Item 2,

wherein a plurality of the concave portions are provided on the inner peripheral surface of the sleeve in a circumferentially arranged manner, and

wherein the peripheral wall portion of the inserted portion of the second hollow member is pressed against and fixed to the inner peripheral surface of the sleeve in a state in which the peripheral wall portion of the inserted portion is circumferentially engaged with the concave portions.

[4] The connection structure for hollow members as recited in the aforementioned Item 2 or 3,

wherein a plurality of the concave portions are provided on the inner peripheral surface of the sleeve in an axially arranged manner, and

wherein the peripheral wall portion of the inserted portion of the second hollow member is pressed against and fixed to the inner peripheral surface of the sleeve in a state in which the peripheral wall portion of the inserted portion is axially engaged with the concave portions.

[5] The connection structure for hollow members as recited in any one of the aforementioned Items 1 to 4,

wherein a radially outwardly protruded flange portion is integrally provided at an end portion of the sleeve, and

wherein the sleeve is fixed to the first hollow member in a state in which the sleeve is inserted in the insertion hole and the flange is in contact with an outer surface or an inner surface of the first hollow member in the vicinity of the insertion hole.

[6] The connection structure for hollow members as recited in any one of the aforementioned Items 1 to 5,

wherein the insertion hole is formed in each of the pair of opposed wall portions of the first hollow member, and

wherein the sleeve is fixed to the first hollow member with the sleeve inserted in both the insertion holes.

[7] The connection structure for hollow members as recited in any one the aforementioned Items 1 to 6,

wherein the first hollow member and the second follow member are a first frame constituent member and a second frame constituent member constituting an automobile frame, respectively.

[8] The connection structure for hollow members as recited in any one of the aforementioned Items 1 to 6,

wherein the first hollow member and the second follow member are a bumper reinforcement and a bumper stay constituting an automobile bumper, respectively.

[9] A method for connecting a first hollow member and a second hollow member,

wherein an insertion hole is formed in at least one of a pair of opposed wall portions of the first hollow member,

the method comprising:

a sleeve fixing step for fixing a sleeve for preventing biting of a peripheral edge portion of the insertion hole into an outer peripheral surface of the second hollow member with the sleeve inserted in the insertion hole; and

an expansion step for expanding a peripheral wall portion of an inserted portion of the second hollow member inserted in the sleeve after inserting the second hollow member in the sleeve so that the peripheral wall portion of the inserted portion of the second hollow member is pressed against and fixed to an inner peripheral surface of the sleeve.

[10] The method for connecting hollow members as recited in the aforementioned Item 9,

wherein a concave portion is provided on the inner peripheral surface of the sleeve, and

wherein, at the expansion step, the peripheral wall portion of the inserted portion of the second hollow member is expanded so that the peripheral wall portion of the inserted portion of the second hollow member is pressed against and fixed to the inner peripheral surface of the sleeve with the peripheral wall portion of the inserted portion engaged with the concave portion.

[11] The method for connecting hollow members as recited in the aforementioned Item 10,

wherein a plurality of the concave portions are provided on the inner peripheral surface of the sleeve in a circumferentially arranged manner, and

wherein, at the expansion step, the peripheral wall portion of the inserted portion of the second hollow member is expanded so that the peripheral wall portion of the inserted portion of the second hollow member is pressed against and fixed to the inner peripheral surface of the sleeve in a state in which the peripheral wall portion of the inserted portion is circumferentially engaged with the concave portions.

[12] The method for connecting hollow members as recited in the aforementioned Item 10 or 11,

wherein a plurality of the concave portions are provided on the inner peripheral surface of the sleeve in an axially arranged manner, and

wherein, at the expansion step, the peripheral wall portion of the inserted portion of the second hollow member is expanded so that the peripheral wall portion of the inserted portion of the second hollow member is pressed against and fixed to the inner peripheral surface of the sleeve in a state in which the peripheral wall portion of the inserted portion is axially engaged with the concave portions.

[13] The method for connecting hollow members as recited in any one of the aforementioned Items 9 to 12,

wherein a radially outwardly protruded flange portion is integrally provided at an end portion of the sleeve, and

wherein, at the sleeve fixing step, the sleeve is fixed to the first hollow member in a state in which the sleeve is inserted in the insertion hole and the flange portion is in contact with an outer surface or an inner surface of the first hollow member in the vicinity of the insertion hole

[14] The method for connecting hollow members as recited in any one of the aforementioned Items 9 to 13,

wherein the insertion hole is formed in each of the pair of opposed wall portions of the first hollow member, and

wherein, at the sleeve fixing step, the sleeve is fixed to the first hollow member with the sleeve inserted in both the insertion holes.

[15] The method for connecting hollow members as recited in any one of the aforementioned Items 9 to 14,

wherein, at the expansion step, the peripheral wall portion of the inserted portion of the second hollow member is expanded by an electromagnetic forming method, a hydraulic bulge forming method, or a rubber bulge forming method.

[16] The method for connecting hollow members as recited in any one of the aforementioned Items 9 to 14,

wherein, at the expansion step, the peripheral wall portion of the inserted portion of the second hollow member is expanded by an expand method using a plurality of opening claws to be inserted into an inside of the peripheral wall portion of the inserted portion of the second hollow member and a mandrel for opening the plurality of opening claws.

[17] The method for connecting hollow members as recited in any one of the aforementioned Items 9 to 16,

wherein the first hollow member and the second follow member are a first frame constituent member and a second frame constituent member constituting an automobile frame, respectively.

[18] The method for connecting hollow members as recited in any one of the aforementioned Items 9 to 16,

wherein the first hollow member and the second follow member are a bumper reinforcement and a bumper stay constituting an automobile bumper, respectively.

[19] An automobile frame in which a first frame constituent member of a hollow member and a second frame constituent member of a hollow member are connected with each other,

wherein the first frame constituent member and the second frame constituent member are connected as the first hollow member and the second hollow member, respectively, by the connection method for hollow members as recited in any one of the aforementioned Items 9 to 16.

[20] An automobile bumper in which a bumper reinforcement of a hollow member and a bumper stay of a hollow member are connected with each other,

wherein the bumper reinforcement and the bumper stay are connected as the first hollow member and the second hollow member, respectively, by the connection method for hollow members as recited in any one of the aforementioned Items 9 to 16.

[21] A method for producing an automobile frame in which a first frame constituent member of a hollow member and a second frame constituent member of a hollow member are connected with each other,

wherein the first frame constituent member and the second frame constituent member are connected as the first hollow member and the second hollow member, respectively, by the connection method for hollow members as recited in any one of the aforementioned Items 9 to 16.

[22] A method for producing an automobile bumper in which a bumper reinforcement of a hollow member and a bumper stay of a hollow member are connected with each other,

wherein the bumper reinforcement and the bumper stay are connected as the first hollow member and the second hollow member, respectively, by the connection method for hollow members as recited in any one of the aforementioned Items 9 to 16.

### EFFECTS OF THE INVENTION

The present invention has the following effects.

According to the invention [1], since the peripheral wall portion of the inserted portion of the second hollow member inserted in the sleeve is expanded in a state in which the second hollow member is inserted in the sleeve, the biting of the peripheral edge portion of the insertion hole of the first hollow member into the outer surface of the second hollow member can be prevented by the sleeve. Thus, the durability of the connection structure can be improved. Furthermore, possible ruptures of the second hollow member which may occur at the time of the expansion operation can be prevented by the sleeve.

Also, there is no need to additionally use a restraining mold to prevent possible ruptures at the time of the expansion operation, which makes it possible to produce the connection structure at low cost and improve the workability.

Furthermore, the peripheral wall portion of the inserted portion of the second hollow member is pressed against and fixed to the inner peripheral surface of the sleeve, which increases the contact area between the sleeve and the second hollow member. This in turn can increase the extraction load.

According to the invention [2], the extraction load can be further increased since the peripheral wall portion of the inserted portion of the second hollow member is pressed against and fixed to the inner peripheral surface of the sleeve in a state in which the peripheral wall portion of the inserted portion is engaged with the concave portion.

According to the invention [3], the extraction load can be further increased and rotating of the second hollow member within the sleeve can be prevented assuredly since the peripheral wall portion of the inserted portion of the second hollow member is pressed against and fixed to the inner peripheral surface of the sleeve in a state in which the peripheral wall portion of the inserted portion is circumferentially engaged with the concave portions.

According to the invention of the aforementioned Item [4], the extraction load can be further increased since the peripheral wall portion of the inserted portion of the second hollow member is pressed against and fixed to the inner peripheral surface of the sleeve in a state in which the peripheral wall portion of the inserted portion is axially engaged with the concave portions.

According to the invention [5], the positioning of the sleeve inserted in the insertion hole of the first hollow member can be easily performed and the falling out of the sleeve from the insertion hole can be prevented assuredly.

According to the invention [6], the extraction load can be further increased.

According to the invention [7], the effects of any one of the aforementioned inventions [1] through [6] can be exerted for automobile frames.

According to the invention [8], the effects of any one of the aforementioned inventions [1] through [6] can be exerted for automobile bumpers.

According to the inventions [9] through [18], the same effects as the effects of any one of the aforementioned inventions [1] through [6] can be exerted.

According to the inventions [19], the effects of any one of the aforementioned inventions [1] through [6] can be exerted for automobile frames.

According to the invention [20], the effects of any one of the aforementioned inventions [1] through [6] can be exerted for automobile bumpers.

According to the invention [21], the same effects as the effects of any one of the aforementioned inventions [1] through [6] can be exerted in manufacturing automobile frames.

According to the invention [22], the same effects as the effects of any one of the aforementioned inventions [1] through [6] can be exerted in manufacturing automobile bumpers.

### BRIEF EXPLANATION OF THE DRAWINGS

FIG. 1 is a plan view of an automobile ladder frame as a connection structure for hollow members according to a first embodiment of the present invention.

FIG. 2 is a cross-sectional view taken along the line X-X in FIG. 1.

FIG. 3A is an enlarged view of FIG. 2.

FIG. 3B is a right side view of FIG. 3A.

FIG. 4 is a cross-sectional view of the connection structure in which the first hollow member and the sleeve are connected.

FIG. 5 is a cross-sectional view before the expansion step.

FIG. 6 is an extraction load diagram.

FIG. 7A is a cross-sectional view of a connection structure for hollow members according to a second embodiment of the present invention.

FIG. 7B is a right side view of FIG. 7A.

FIG. 8 is a cross-sectional view of a connection structure for hollow members according to a third embodiment of the present invention.

FIG. 9 is a cross-sectional view of a connection structure for hollow members according to a fourth embodiment of the present invention.

FIG. 10 is a cross-sectional view of a connection structure for hollow members according to a fifth embodiment of the present invention.

FIG. 11A is a cross-sectional view of a connection structure for hollow members according to a sixth embodiment of the present invention.

FIG. 11B is a right side view of FIG. 11A.

FIG. 12A is a cross-sectional view of a connection structure for hollow members according to a seventh embodiment of the present invention.

FIG. 12B is a right side view of FIG. 12B.

FIG. 13A is a cross-sectional view of a connection structure for hollow members according to an eighth embodiment of the present invention.

FIG. 13B is a right side view of FIG. 13A.

FIG. 14A is a cross-sectional view of a connection structure for hollow members according to a ninth embodiment of the present invention.

FIG. 14B is a right side view of FIG. 14A.

FIG. 15A is a cross-sectional view of a connection structure for hollow members according to a tenth embodiment of the present invention.

FIG. 15B is a right side view of FIG. 15A.

FIG. 16A is a cross-sectional view of a connection structure for hollow members according to an eleventh embodiment of the present invention.

FIG. 16B is a right side view of FIG. 16A.

FIG. 17A is a cross-sectional view of a connection structure for hollow members according to a twelfth embodiment of the present invention.

FIG. 17B is a right side view of FIG. 17A.

FIG. 18A is a cross-sectional view of a connection structure for hollow members according to a thirteenth embodiment of the present invention.

FIG. 18B is a right side view of FIG. 18A.

FIG. 19 is a partially cutout plan view of an automobile bumper as a connection structure for hollow members according to a fourteenth embodiment of the present invention.

FIG. 20 is a cross-sectional view showing the state before performing an expansion step by an expansion method using a plurality of opening claws and a mandrel.

FIG. 21A is a front view of the opening claws.

FIG. 21B is a partially cutout side view of FIG. 21A.

FIG. 22A is a front view of the mandrel.

FIG. 22B is a side view of FIG. 22A.

FIG. 23 is a cross-sectional view of the connection structure according to Example 1.

FIG. 24 is a cross-sectional view of Comparative Example 1.

FIG. 25 is a cross-sectional view of Comparative Example 2.

FIG. 26 is a cross-sectional view of a conventional connection structure.

FIG. 27 is an enlarged view showing the “Z” portion in FIG. 26.

### DESCRIPTION OF REFERENCE NUMERALS

A1-A16 . . . connection structure
1 . . . ladder frame (automobile frame)
1a . . . side member
1b . . . cross member
2 . . . bumper
2a . . . bumper reinforcement
2b . . . bumper stay
10 . . . first hollow member (side member, bumper reinforcement)
11 . . . opposed walls
12 . . . insertion hole
12a . . . peripheral edge portion
20 . . . second hollow member (cross member, bumper stay)
22 . . . peripheral wall portion
30 . . . sleeve
31 . . . flange portion
33 . . . concave portion
40 . . . electromagnetic forming device (expanding device)
41 . . . coil
45 . . . expanding device
46 . . . opening claw
47 . . . mandrel
W . . . welded portion

### BEST MODE FOR CARRYING OUT THE INVENTION

Next, some preferred embodiments of the present invention will be explained with reference to the drawings.

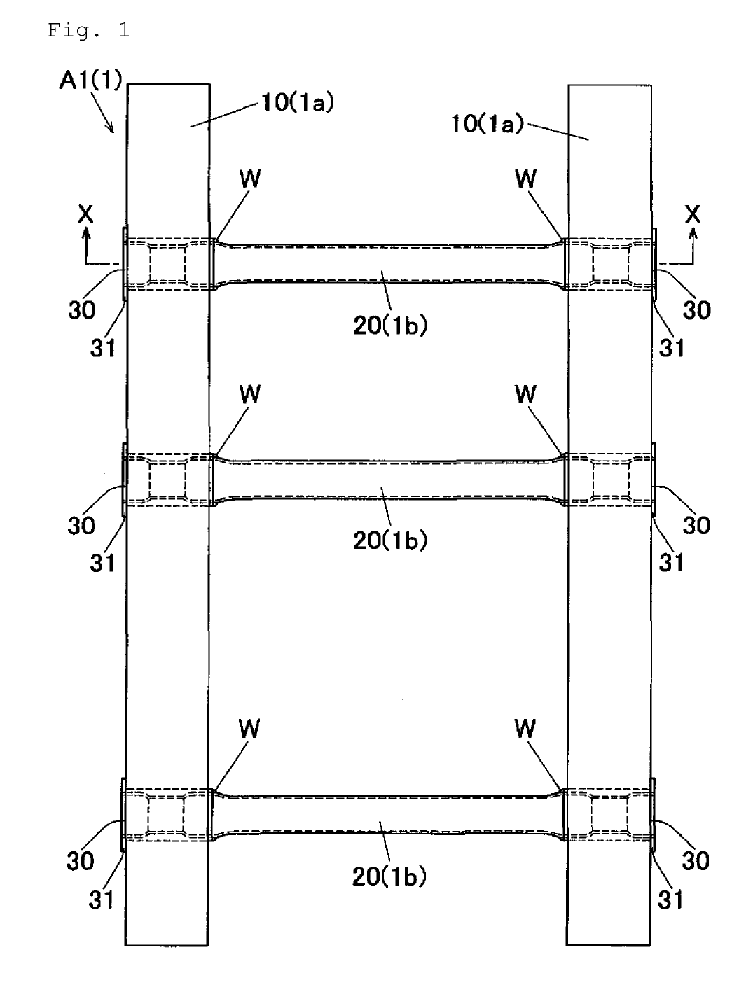

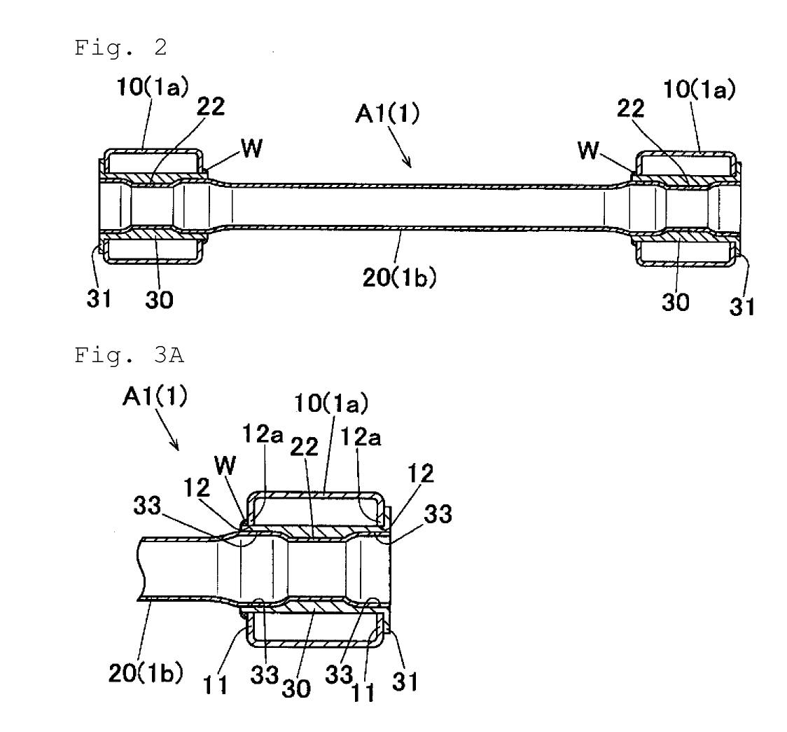

FIGS. 1 to 5 are explanatory views for explaining a first embodiment of the present invention. In FIG. 1, “1” denotes a ladder frame for automobiles, such as, e.g., trucks, as a connection structure for hollow members “A1” according to the first embodiment. This ladder frame 1 is equipped with a pair of right and left side members 1a and 1a, and a plurality (three in this embodiment) of cross members 1b, 1b and 1b placed between and linking the side members 1a and 1a.

Each side member 1a and each cross member 1b are each made of a hollow member. The side member 1a corresponds to the first frame constituent member, one of a plurality of frame constituent members constituting the ladder frame 1. The cross member 1b corresponds to the second frame constituent member, another one of a plurality of frame constituent members constituting the ladder frame 1.

In this first embodiment, the following explanation will be directed to an example in which both hollow members 10 and 20, a first hollow member 10 as the side member 1a of the ladder frame 1 and a second hollow member 20 as the cross member 1b, are connected perpendicularly.

The cross-section of the first hollow member 10 is polygonal, more specifically quadrilateral. Also, the first hollow member 10 is made of plastically deformable material, more specifically metal, such as, e.g., aluminum or aluminum alloy.

The cross-section of the second hollow member 20 is polygonal, more specifically quadrilateral and further more specifically square. Also, the second hollow member 20 is made from plastically deformable materials, more specifically metal, such as, e.g., aluminum or aluminum alloy.

In the present invention, as the material for the first hollow member 10 and the second hollow member 20, aluminum or aluminum alloy and other materials, such as, e.g., steel, magnesium alloy, and FRP resin, can be used. Especially, the first hollow member 10 and the second hollow member 20 are preferably made of extruded material of aluminum, aluminum alloy, or magnesium alloy. Also, the material of the first hollow member 10 and that of the second hollow member 20 can be the same or different from each other. In the present invention, however, the materials for the hollow members 10 and 20 are not limited to the materials mentioned above.

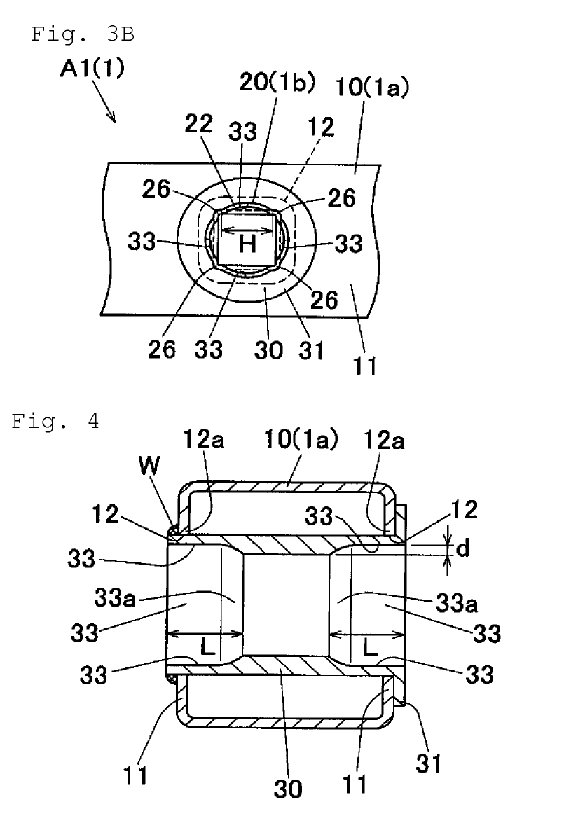

As shown in FIG. 3A and FIG. 3B, an insertion hole 12 is formed in each of the pair of opposed wall portions 11 and 11 of the first hollow member 10. A sleeve 30, which will be mentioned later, will be inserted into both the insertion holes 12 and 12 in a fitted manner. The cross-section of each of the insertion hole 12 is approximately quadrilateral (quadrilateral) (see FIG. 3B) and the cross-sections of both the insertion holes 12 and 12 are the same with each other.

“30” denotes a cylindrical sleeve. This sleeve 30 prevents the peripheral edge portion 12a of each insertion hole 12 of the first hollow member 10 from biting into the outer peripheral surface of the second hollow member 20. The sleeve 30 is rigid, and, for example, made of metal, such as, e.g., aluminum or aluminum alloy.

In the present invention, aluminum or aluminum alloy and other materials, such as, e.g., steel and magnesium alloy, can be used as the material for the sleeve 30. In the present invention, however, the material for the sleeve 30 is not limited to the material mentioned above.

The cross-section of the outer peripheral surface of the sleeve 30 corresponds to the cross-sectional shape of the insertion hole 12, and more specifically the same shape as the cross-section of the insertion hole 12.

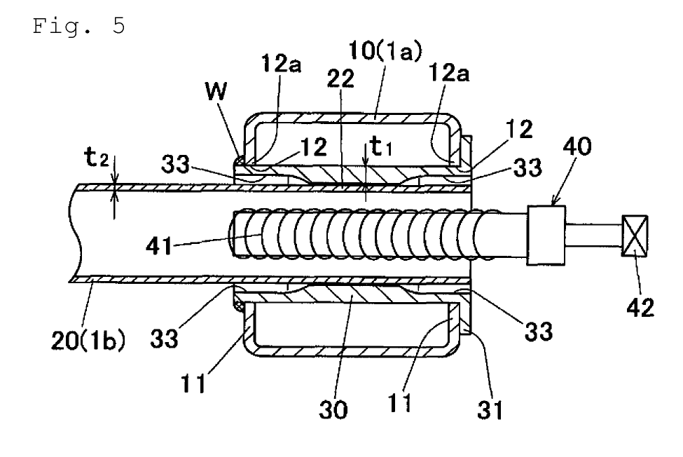

As shown in FIG. 5, it is preferable that the thickness t1 of the sleeve 30 is set to be equal to or larger than the thickness t2 of the second hollow member 20, i.e., t1≧t2.

Also, at one end portion of the sleeve 30, a radially outwardly protruded flange portion 31 is integrally formed along the entire circumference thereof.

As shown in FIG. 3B, the cross-section of the inner peripheral surface of the sleeve 30 (i.e. the cross-section of the hollow member of the sleeve 30) is basically formed into a shape capable of inserting the second hollow member 20 in a fitted manner, i.e., a square shape. Furthermore, as shown in FIGS. 3A, 3B and 4, a plurality of concave portions 33 (eight concave portions in this Embodiment 1) are integrally formed on the inner peripheral surface of the sleeve 30 in such a manner that they are arranged in a circumferentially detached and axially detached manner. In detail, four concave portions among the plurality of concave portions 33 (eight concave portions) are circumferentially arranged at one axial end portion of the inner peripheral surface of the sleeve 30 in a detached manner (see FIG. 3B), and the remaining four concave portions 33 among the plurality of concave portions (eight concave portions in this Embodiment 1) are circumferentially arranged at the other axial end portion of the inner peripheral surface of the sleeve 30 in a detached manner. On the other hand, no such a concave portion 33 is formed at the axial intermediate portion of the inner peripheral surface of the sleeve 30. Thus, the cross-section of the axial intermediate portion of the inner peripheral surface of the sleeve 30 is the same as the cross-section of the second hollow member 20. Therefore, the second hollow member 20 will be inserted into the axial intermediate portion in the sleeve 30 in a fitted manner. The cross-section of each of the concave portions 33 is formed into an approximately L-shape in the longitudinal direction of the sleeve 30 and an approximately circular shape in the transverse direction of the sleeve 30.

In the present invention, the number of the concave portions 33 are not limited to eight (8), and can be, for example, one (1), two (2) to seven (7), or nine (9) or more.

Next, a method of connecting the first hollow member 10 and the second hollow member 20 will be explained.

First, as shown in FIG. 4, the sleeve 30 is inserted into both the insertion holes 12 and 12 of the first hollow member 10 so that the sleeve 30 connects both the insertion holes 12 and 12 and are fitted therein, and the flange portion 31 is brought into face-to-face contact with an outer surface of the first hollow member 10 in the vicinity of one of the two insertions holes 12 and 12 of the first hollow member 10. While keeping this state, the other end portion of the sleeve 30 is welded to the peripheral edge portion 12a of the insertion hole 12 along the entire circumference thereof (the welded portion is denoted as “W”). As a result, the sleeve 30 is fixed to the first hollow member 10 so that the sleeve 30 would not move axially and would not rotate in the insertion hole 12 [sleeve fixing process].

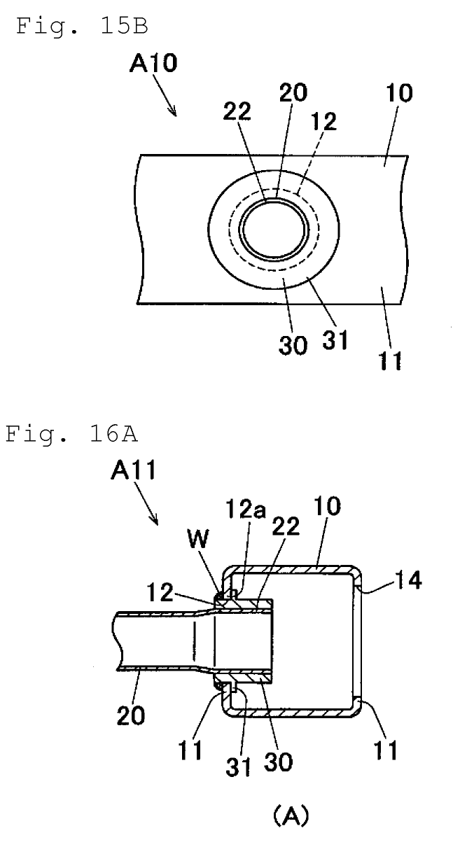

In the present invention, as the fixing means for fixing the sleeve 30 to the first hollow member 10, welding, such as, e.g., MIG welding, TIG welding, laser beam welding, and other methods such as friction agitation welding (see FIG. 15), can also be used as will be explained later. In cases where welding is employed as a fixing method, for example, the welding is preferably performed by automatic MIG welding at a bead of one pass per place. However, the present invention does not limit the fixing method to welding or friction agitation welding, and allows any fixing method.

Next, as shown in FIG. 5, one end portion of the second hollow member 20 is inserted into the sleeve 30 along the entire axial length of the sleeve 30. In this inserted state, the second hollow member 20 is inserted in the axial intermediate portion of the sleeve 30 in a fitted manner. Therefore, the second hollow member 20 will not rotate within the sleeve 30. Next, in this state, the peripheral wall portion 22 of the inserted portion of the second hollow member 20 inserted in the sleeve 30 is expanded (tube expansion) [Expanding process].

In the present invention, various known methods can be employed for expanding the peripheral wall portion 22 of the second hollow member 20 by applying pressure to the peripheral wall portion 22 from the inside thereof. More specifically, methods, such as, e.g., an electromagnetic forming method, a hydraulic bulge forming method, and a rubber bulge forming method, can be used.

In this first Embodiment 1, an electromagnetic forming method is employed as the expanding method. The electromagnetic forming device 40 used for the electromagnetic forming method is a commercially available known device equipped with an electromagnetic coil 41, a power supply 42, etc.

The expansion method using the electromagnetic forming device 40 will be explained as follows.

First, from the end portion side opening of the second hollow member 20, the electromagnetic coil 41 of the electromagnetic forming device 40 is inserted inside the peripheral wall portion 22 of the inserted portion of the second hollow member 20 inserted in the sleeve 30. Next, as shown in FIG. 5, when the tip end of the coil 41 reaches the other end position of the sleeve 30, the insertion of the coil 41 is stopped. Then, electrical current is supplied from the power supply 42 to the coil 41, so that the peripheral wall portion 22 is expanded by the electromagnetic power generated by the coil 41. While being plastically deformed, a part of the peripheral wall portion 22 expands towards each of the concave portions 33 of the sleeve 30 and engages with the concave portions 33 circumferentially and axially. In this state, the peripheral wall portion 22 is pressed against and fixed to the inner peripheral surface of the sleeve 30. In this state, as shown in FIGS. 3A and 3B, the peripheral wall portion 22 is in close face-to-face contact with the inner peripheral surface of the sleeve 30, and more specifically, in close face-to-face contact with the inner peripheral surface of the sleeve 30 along the entire circumference thereof. In FIG. 3B, “26” denotes an angular portion of the peripheral wall portion 22 of the second hollow member 20 remained unexpanded.

The shape of the concave portion 33 of the sleeve 30 will be explained concretely as follows.

In the cross-section shown in FIG. 4, i.e. the longitudinal cross-section of the sleeve 30, the depth “d” of the concave portion 33 is preferably 0.1 times or more (more preferably, 0.5 times or more) the thickness “t2” of the second hollow member 20. Also, the length “L” of the concave portion 33 (a total length in cases where a plurality of the concave portions 33 are axially arranged) is preferably 10% or more of the entire length of the sleeve 30.

In the concave portion 33, it is preferable that both the connecting portion 33a connecting the concave portion 33 the non-concave portion and the connecting portion circumferentially connecting the adjacent concave portions 33 are gradually decreased in depth.

Also, in the cross-section shown in FIG. 3B, the range H in which the concave portion 33 is formed on one side of the sleeve 30 opposed to one side of the second hollow member 20 (i.e., the width of the concave portion 33) preferably meets the condition: H≦H0−2R (Unit: mm), where H0 is a length of one side of the second hollow member 20 (in cases where the angular portion has an R, the base point is an intersecting point where extended sides are crossed), and R is an outer curvature radius of the angular portion 26 of the second hollow member 20.

In Embodiment 1, the peripheral wall portion of the second hollow member 20 axially protruded from the sleeve 30, i.e. the peripheral wall portion of the second hollow member 20 positioned at the left side of the sleeve 30 shown in FIG. 3A, is not expanded so as to have a diameter larger than the inner diameter of the left end portion of the sleeve 30. This prevents biting of the left end edge of the sleeve 30 into the outer peripheral surface of the peripheral wall portion.

In the present invention, as the expanding method, an electromagnetic forming method and other methods including, for example, a hydraulic bulge forming method or a rubber bulge forming method, can be employed. Alternatively, as will be explained later, an expanding method (see FIGS. 20 to 22B) using a plurality of opening claws and a mandrel for opening the plurality of opening claws can also be used.

In accordance with the aforementioned steps, the second hollow member 20 is integrally connected to the first hollow member 10 via the sleeve 30, whereby the connection structure A1 is produced.

The connection structure A1 obtained in this way has the following advantages.

That is, the inserted portion of the peripheral wall portion 22 of the second hollow member 20 inserted into the sleeve 30 is expanded in a state in which the second hollow member 20 is inserted into the sleeve 30. This prevents biting of the peripheral edge portion 12a of the insertion hole 12 of the first hollow member 10 into the outer peripheral surface of the second hollow member 20. Therefore, the durability of the connection structure A1 (i.e. the ladder frame 1) can be improved.

Furthermore, there is no need to separately use a restraining mold for preventing possible ruptures of the second hollow member at the time of the expansion process, enabling low cost production of the connection structure A1 and improved workability.

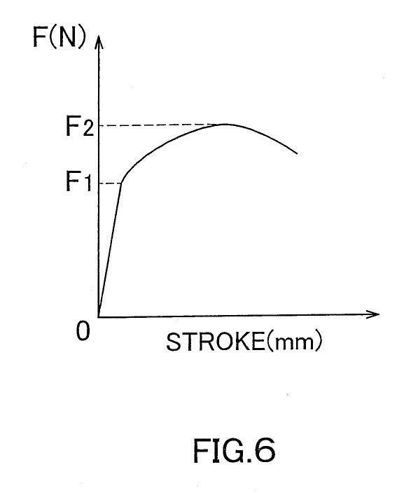

Furthermore, by expanding the peripheral wall portion 22 of the second hollow member 20, the peripheral wall portion 22 is pressed against and fixed to the inner peripheral surface of the sleeve 30, so that the contact area between the sleeve 30 and the second hollow member 20 (more specifically, the peripheral wall portion 22 of the second hollow member 20) is large. Therefore, the extraction load can be increased. The reasons for that will be explained below with reference to FIG. 6.

FIG. 6 is a common extraction load diagram for extracting the second hollow member. In the diagram, the horizontal axis shows a stroke and a vertical axis shows an extraction load F. Further, “F1” denotes a proportional limit load (proportional limit load) and “F2” denotes a maximum load. The proportional limit load F1 is a load that the second hollow member starts to move or slide in the axial direction.

F1 can be given by the following equation (i).

F1=μ×A×P (i)

where “μ” is a friction coefficient, “A” is a contact area, and “P” is a remaining surface pressure after the expansion step.

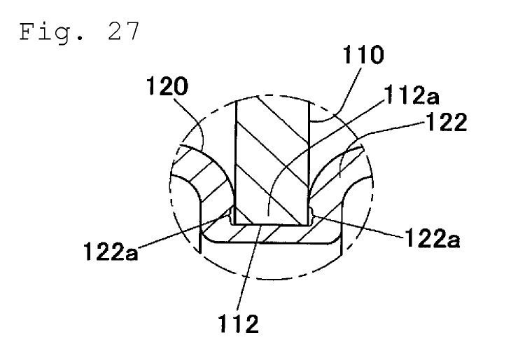

As shown in the figure, the load in which the stroke is close to “0” will be dominated by F1. Therefore, if it is presumed that “μ” and “P” in the connection structure A1 of this Embodiment 1 shown in FIG. 3A are equal to “μ” and “P” of the conventional connection structure B3 shown in FIGS. 26 and 27, an increase in F1 can be performed by increasing the contact area A. In the conventional connection structure B3, however, only the peripheral edge portion 112a of the insertion hole 112 of the first hollow member 110 is in contact with the outer peripheral surface of the second hollow member 120. Therefore, the contact area A is small, and thus F1 is small. On the other hand, in the connection structure A1 of this Embodiment 1, the peripheral wall portion 22 of the second hollow member 20 is in face-to-face contact with the inner peripheral surface of the sleeve 30, so that the contact area A is large. Therefore, F1 is large. For that reason, the connection structure A1 of this Embodiment 1 has a larger extraction load than that of the conventional connection structure B3. The load between F1 and F2 is a load which will be required for crushing the protruded portion (i.e. the expanded portion) of the second hollow member 20, which depends on the material strength and the amount of expansion of the second hollow member 20. However, this is a load imparted after initiation of the extraction of the second hollow member 20 and therefore it is not so important.

Furthermore, in Embodiment 1, the sleeve 30 can prevent possible ruptures of the second hollow member 20 that may occur during the expansion step.

Furthermore, since the peripheral wall portion 22 of the second hollow member 20 is pressed against and fixed to the inner peripheral surface of the sleeve 30 in a state in which the peripheral wall portion 22 of the second hollow member 20 is circumferentially engaged with the concave portions 33, the extraction load can be further increased and rotating of the second hollow member 20 within the sleeve 30 can be assuredly prevented. Furthermore, the peripheral wall portion 22 of the second hollow member 20 is pressed against and fixed to the inner peripheral surface of the sleeve 30 in a state in which the peripheral wall portion 22 of the second hollow member 20 is axially engaged with the concave portions 33, so that the extraction load can be further increased.

Furthermore, the flange portion 31 is integrally formed at the end portion of the sleeve 30, which enables easy axial positioning of the sleeve 30 inserted in the insertion holes 12 and assured prevention of extraction of the sleeve 30 from the insertion holes 12.

Furthermore, the insertion hole 12 is formed in each of the pair of opposed wall portions 11 and 11 of the first hollow member 10 and the sleeve 30 is fixed to the first hollow member 10 with the sleeve 30 inserted into both of the insertion holes 12 and 12, so that the extraction load can be further increased.

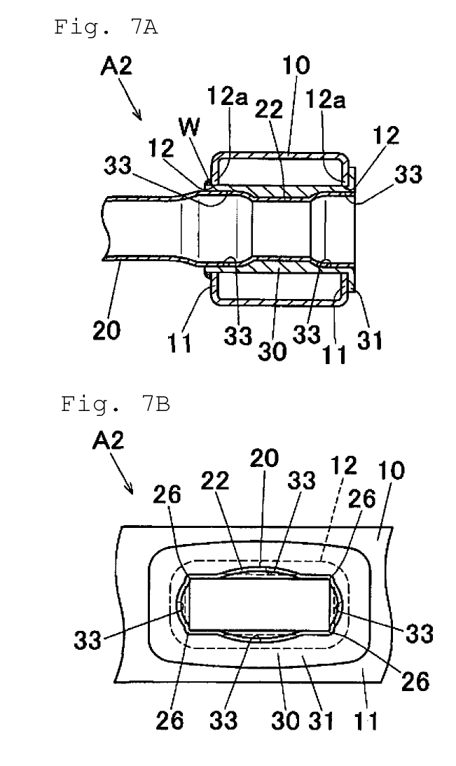

FIGS. 7A to 22B are explanatory views for explaining several connection structures according to embodiments of the present invention. In these figures, the same reference numerical symbols are allotted to elements corresponding the elements of the connection structure A1 of the abovementioned Embodiment 1.

In the connection structure A2 according to Embodiment 2 of the present invention shown in FIGS. 7A and 7B, the cross-section of each of the insertion holes 12 is quadrilateral, more specifically rectangular. Also, the cross-section of the second hollow member 20 is quadrilateral, more specifically rectangular.

The sleeve 30 has a cylindrical shape square in cross-section. Four concave portions 33 are circumferentially arranged at one axial end portion of the inner peripheral surface of the sleeve 30 in a detached manner in the same manner as in the connection structure A1 of the abovementioned Embodiment 1, and also four concave portions 33 are circumferentially arranged at the other axial end portion of the inner peripheral surface of the same sleeve 30 in a detached manner. However, no concave portion are formed at the axial intermediate portion of the inner peripheral surface of the sleeve 30.

The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30 with the peripheral wall portion 22 circumferentially and axially engaged with the concave portions 33.

In the connection structure A3 according to Embodiment 3 of the present invention shown in FIG. 8, the cross-section of each of the insertion holes 12 is circular. The cross-section of the second hollow member 20 is also circular.

The sleeve 30 is cylindrical. Two concave portions 33 and 33 each extending along the entire circumference thereof are axially arranged on the inner peripheral surface of the sleeve 30 in a detached manner. The cross-section of each concave portion 33 is a circular arc shape. More specifically, a single concave portion 33 with a circular arc shaped cross-section extending along the entire circumference thereof is formed at one axial end portion of the inner peripheral surface of the sleeve 30, and a single concave portion 33 with a circular arc shaped cross-section extending along the entire circumference thereof is formed at the other axial end portion of the inner peripheral surface of the sleeve 30.

The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30 with the peripheral wall portion 22 axially engaged with the concave portion 33.

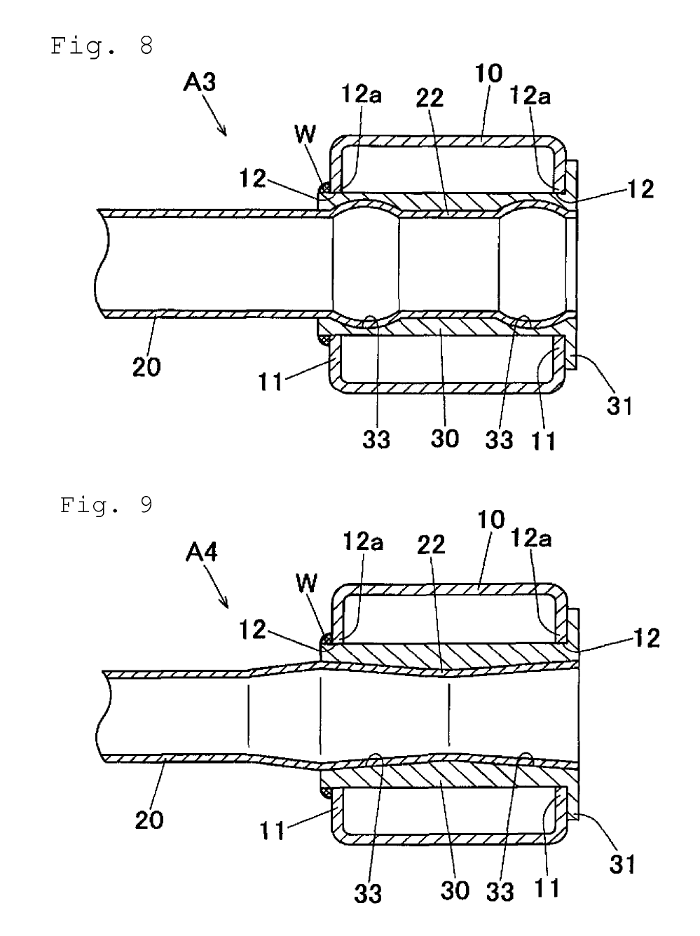

In the connection structure A4 according Embodiment 4 of the present invention shown in FIG. 9, the cross-sections of each insertion hole 12 is circular. The cross-section of the second hollow member 20 is also circular.

The sleeve 30 is cylindrical. Also, the area ranging from the axially intermediate portion of the inner peripheral surface to one end portion of the sleeve 30 and the area ranging from the axial intermediate portion to the other end portion of the sleeve 30 each has a tapered shape. Thus, the tapered concave portion 33 which gradually increases in depth from the axial intermediate portion to one end portion and extends along the entire circumference thereof is formed at the area ranging from the axially intermediate portion of the inner peripheral surface to one end portion of the sleeve 30, and the tapered concave portion 33 which gradually increases in depth from the axial intermediate portion of the sleeve to the other end portion thereof and extends along the entire circumference thereof is formed at the area from the axially intermediate portion of the inner peripheral surface of the sleeve 30 to the other end portion thereof.

The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30 with the peripheral wall portion 22 axially engaged with the concave portions 33.

In the connection structure A5 according to Embodiment 5 of the present invention shown in FIG. 10, the cross-section of each insertion hole 12 is circular. The cross-section of the second hollow member 20 is also circular.

The sleeve 30 is cylindrical. Furthermore, a single concave portion 33 extending in the entire circumference thereof is formed at the axial intermediate portion of the inner peripheral surface of the sleeve 30. The cross-section of the concave portion 33 is a V-shape.

The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30 with the peripheral wall portion 22 axially engaged with the concave portion 33.

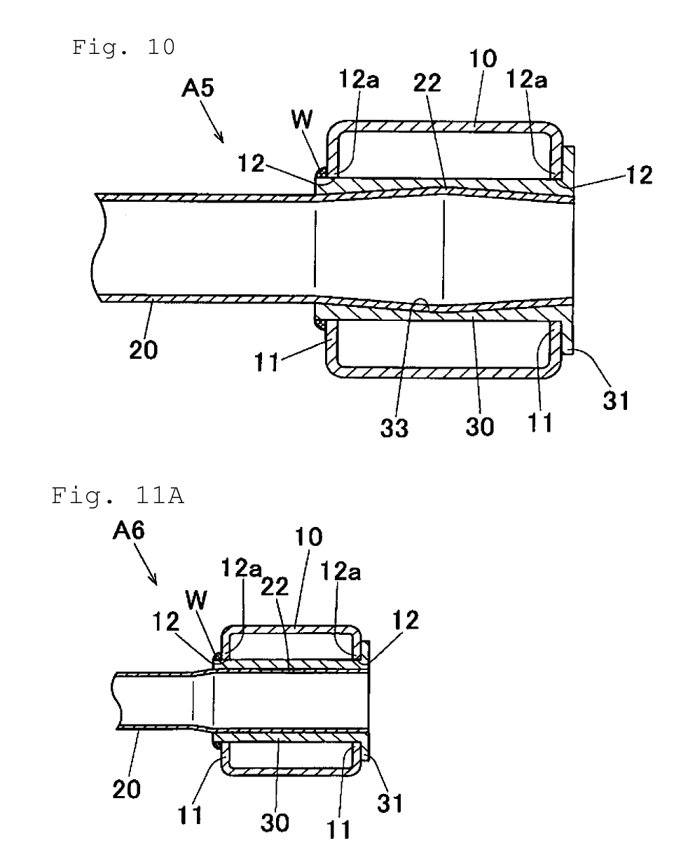

In the connection structure A6 according to Embodiment 6 of the present invention shown in FIGS. 11A and 11B, the cross-section of each insertions hole 12 is circular. The cross-section of the second hollow member 20 is also circular.

The sleeve 30 is cylindrical. No concave portion is formed on the inner peripheral surface of the sleeve 30, i.e., the inner diameter of the sleeve 30 is constant along the axial direction thereof. The cross-section of the inner peripheral surface of the sleeve 30 (i.e. the cross-section of the hollow portion of the sleeve 30) is circular. The inner diameter of the sleeve 30 is set to be larger than the outer diameter of the second hollow member 20. Therefore, before the expansion, the second hollow member 20 is inserted into the sleeve 30 in a loosely-inserted manner.

The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30.

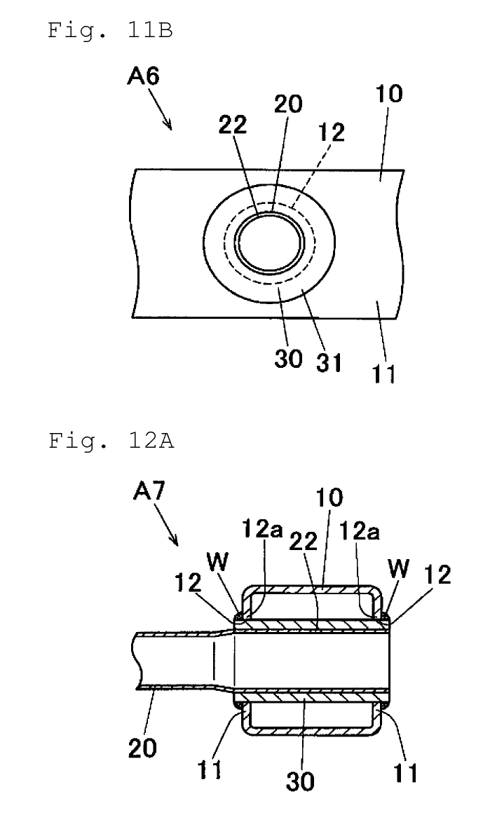

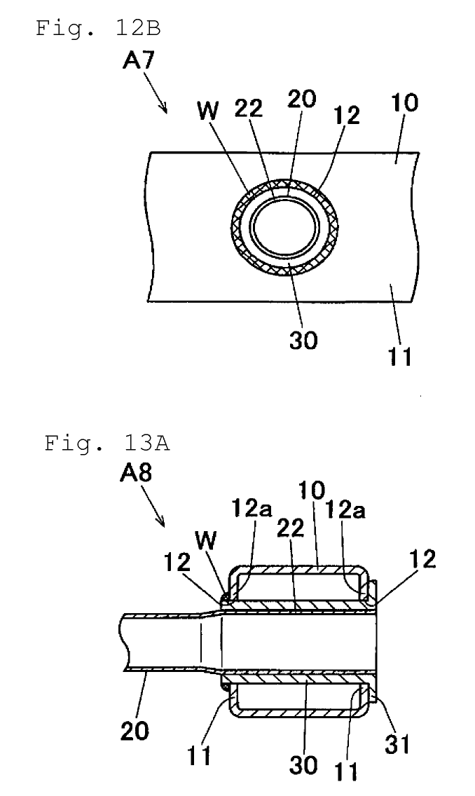

In the connection structure A7 according to Embodiment 7 of the present invention shown in FIGS. 12A and 12B, the cross-section of each insertion hole 12 is circular. The cross-section of the second hollow member 20 is also circular.

The sleeve 30 is cylindrical. No concave portion is formed on the inner peripheral surface of the sleeve 30, i.e., the inner diameter of the sleeve 30 is constant along the axial direction thereof. The cross-section of the inner peripheral surface of the sleeve 30 (i.e. the cross-section of the hollow portion of the sleeve 30) is circular. Also, the inner diameter of the sleeve 30 is set to be larger than the outer diameter of the second hollow member 20. Therefore, before the expansion, the second hollow member 20 is inserted into the sleeve 30 in a loosely-inserted manner. Furthermore, the sleeve 30 has no flange portion.

Both the end portions of the sleeve 30 are welded along the entire circumference of the peripheral edge portions 12a of each of the insertion holes 12 in a state in which the sleeve 30 is inserted into both the insertion holes 12 and 12 of the first hollow member 10, so that the sleeve 30 is fixed to the first hollow member 10. The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30.

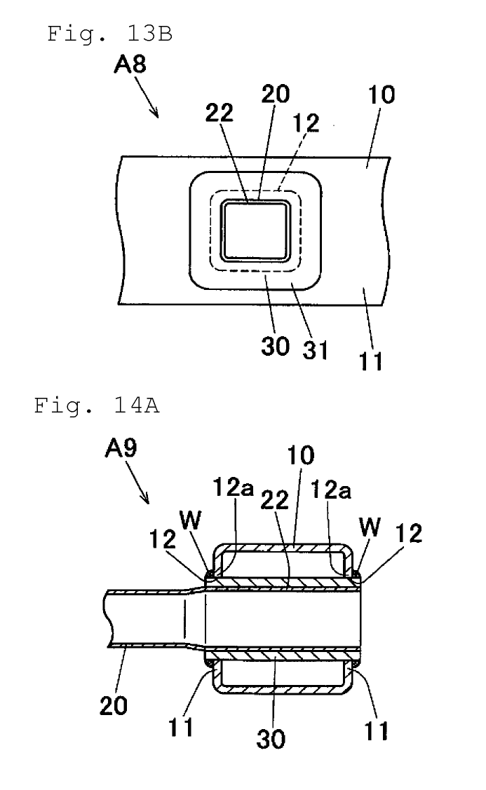

In the connection structure A8 according to Embodiment 8 of the present invention shown in FIGS. 13A and 13B, the cross-section of each of the insertion holes 12 is quadrilateral, more specifically square. The cross-section of the second hollow member 20 is also quadrilateral, more specifically square.

The sleeve 30 is quadrilateral cylindrical in shape. No concave portion is formed on the inner peripheral surface of the sleeve 30, so that the inner diameter of the sleeve 30 is constant along the axial direction thereof. Also, the inner diameter of the sleeve 30 is set to be larger than the outer diameter of the second hollow member 20. Therefore, before the expansion, the second hollow member 20 is inserted into the sleeve 30 in a loosely-inserted manner.

The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30.

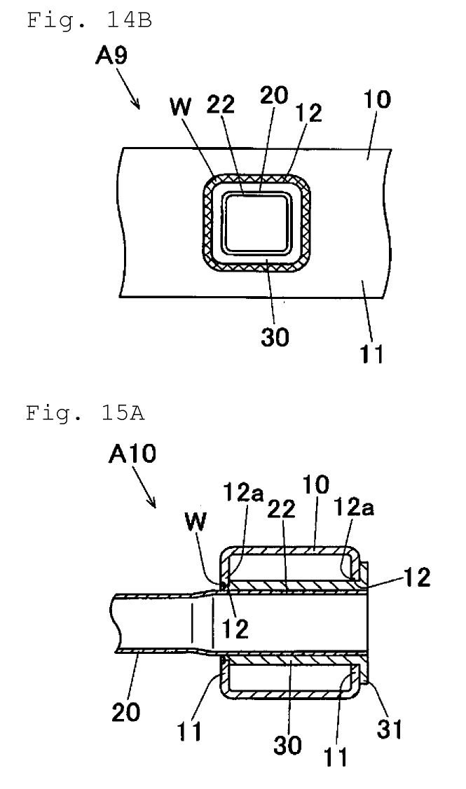

In the connection structure A9 according to Embodiment 9 of the present invention shown in FIGS. 14A and 14B, the cross-section of each of the insertion holes 12 is quadrilateral, more specifically square. The cross-section of the second hollow member 20 is also quadrilateral, more specifically square.

The sleeve 30 is quadrilateral cylindrical in shape. No concave portion is formed on the inner peripheral surface of the sleeve 30, so that the inner diameter of the sleeve 30 is constant along the axial direction thereof. Also, the inner diameter of the sleeve 30 is set to be larger than the outer diameter of the second hollow member 20. Therefore, before the expansion, the second hollow member 20 is inserted in to the sleeve 30 in a loosely-inserted manner. The sleeve 30 has no flange portion.

Both the end portions of the sleeve 30 are welded along the entire circumference of the peripheral edge portions 12a of each of the insertion holes 12 in a state in which the sleeve 30 is inserted into both the insertion holes 12 and 12 of the first hollow member 10, so that the sleeve 30 is fixed to the first hollow member 10. The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30.

The connection structure A10 according to Embodiment 10 of the present invention shown in FIGS. 15A and 15B has the same structure as the connection structure A6 of Embodiment 6 shown in FIGS. 11A and 11B, except that the connection between the first hollow member 10 and the sleeve 30 is performed by a friction agitation welding method in place of a normal welding method. That is, the end portion of the sleeve 30 is welded by a friction agitation welding method (the connected portion is denoted as “W”) along the entire circumference of the peripheral edge portion 12a of the insertion hole 12 in a state in which the sleeve 30 is inserted into both of the insertion holes 12 and 12 of the first hollow member 10, so that the sleeve 30 is fixed to the first hollow member 10. The other structures of the connection structure A10 is the same as those of the connection structure A6 of Embodiment 6.

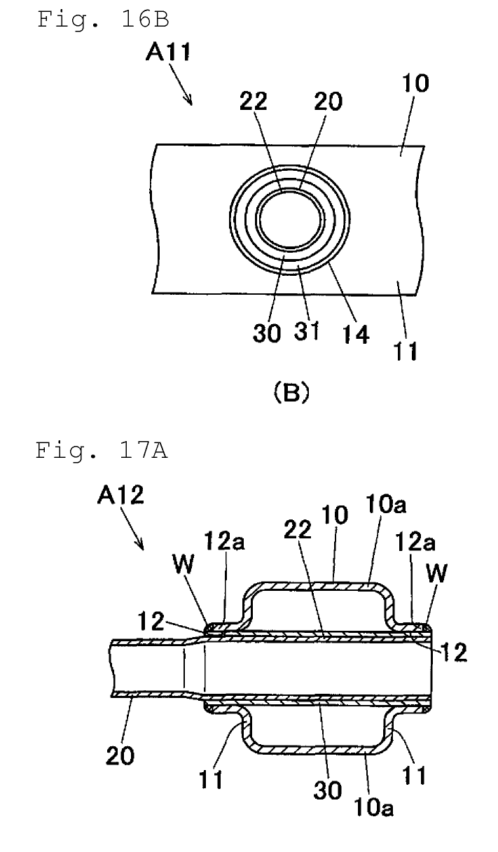

In the connection structure A11 according to Embodiment 11 of the present invention shown in FIGS. 16A and 16B, an insertion hole 12 is formed in only one of the wall portions 11 of the pair of opposed wall portions 11 and 11 of the first hollow member 10. The cross-section of the insertion hole 12 is circular. The cross-section of the second hollow member 20 is circular.

The sleeve 30 is cylindrical. No concave portion is formed on the inner peripheral surface of the sleeve 30, so that the inner diameter of the sleeve 30 is constant along the axial direction thereof. The inner diameter of the sleeve 30 is set to be larger than the outer diameter of the second hollow member 20. Therefore, before the expansion, the second hollow member 20 is inserted into the sleeve 30 in a loosely-inserted manner. The radially outwardly protruded flange portion 31 is integrally formed on the axially intermediate portion of the sleeve 30.

The sleeve 30 is inserted into the insertion hole 12, and the flange portion 31 is brought into face-to-face contact with an inner surface of the first hollow member 10 in the vicinity of the insertion hole 12 of the first hollow member 10. With this state, the end portion of the sleeve 30 is welded to the peripheral edge portion 12a of the insertion hole 12 along the entire circumference thereof, so that the sleeve 30 is fixed to the first hollow member 10. The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30. The reference numeral “14” denotes an opening for introducing the sleeve 30 into the first hollow member 10 when inserting the sleeve 30 into the insertion hole 12.

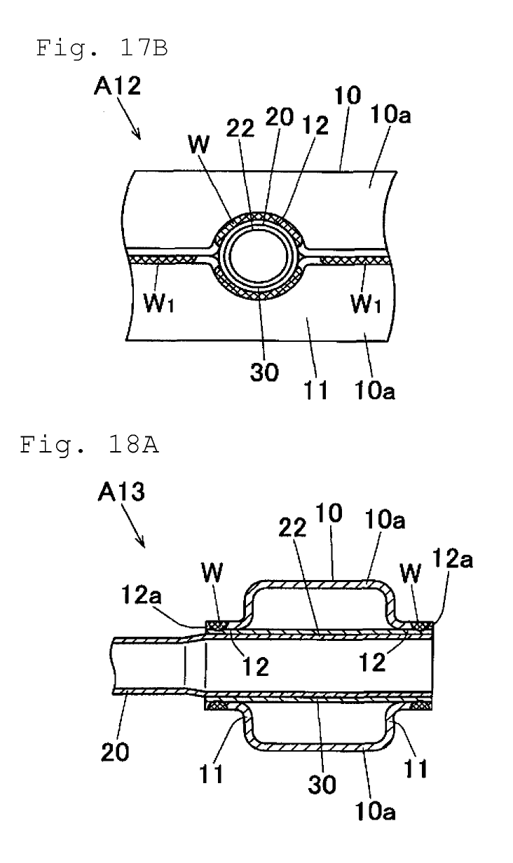

In the connection structure A12 according to Embodiment 12 of the present invention shown in FIGS. 17A and 17B, the first hollow member 10 is a member formed by integrally connecting two members 10a and 10a each having a U-shape in cross-section with the opening edges fitted with each other. “W1” denotes a welded portion formed by welding side edge portions of both the members 10a and 10a. At each side edge portion of one of the members 10a and 10a, a concave portion with a semicircular cross-section is formed by bending a part of the side edge portion. In the same manner, at each side edge portion of the other member 10a, a concave portion with a semicircular cross-section is formed by bending a part of the side edge portion. Both the concave portions are fitted with each other, so that an insertion hole 12 with a circular cross-section is formed.

The sleeve 30 is cylindrical. No concave portion is formed on the inner peripheral surface of the sleeve 30, so that the inner diameter of the sleeve 30 is constant along the axial direction thereof. The inner diameter of the sleeve 30 is set to be larger than the outer diameter of the second hollow member 20. Therefore, before the expansion, the second hollow member 20 is inserted into the sleeve 30 in a loosely-inserted manner. The sleeve 30 has no flange portion.

Both end portions of the sleeve 30 are fillet welded to the peripheral edge portions 12a of each insertion hole 12 along the entire circumference thereof in a state in which the sleeve 30 is inserted into both the insertion holes 12 and 12 of the first hollow member 10, so that the sleeve 30 is fixed to the first hollow member 10. The peripheral wall portion 22 of the inserted portion of the second hollow member 20 inserted into the sleeve 30 is expanded in a state in which the second hollow member 20 is inserted into the sleeve 30, so that the peripheral wall portion 22 is pressed against and fixed to the inner peripheral surface of the sleeve 30.

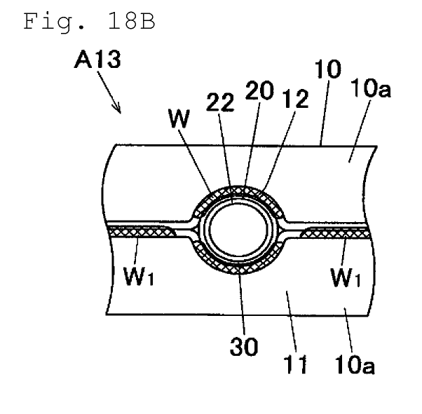

The connection structure A13 according to Embodiment of the present invention shown in FIGS. 18A and 18B is essentially the same as the connection structure A12 of the abovementioned Embodiment 12, but they are connected in different ways. Both end portions of the sleeve 30 are lap welded to the peripheral edge portions 12a of each insertion hole 12 along the entire circumference thereof. In the connection structure A13, the welded portion W is formed from the surface of the peripheral edge portion 12a of the insertion hole 12 up to a region located at a thickness intermediate part of the sleeve 30 beyond the thickness of the peripheral edge portion 12a. The other structures of the connecting structure A13 is the same as those of the connecting structure A12 of the abovementioned Embodiment 12.

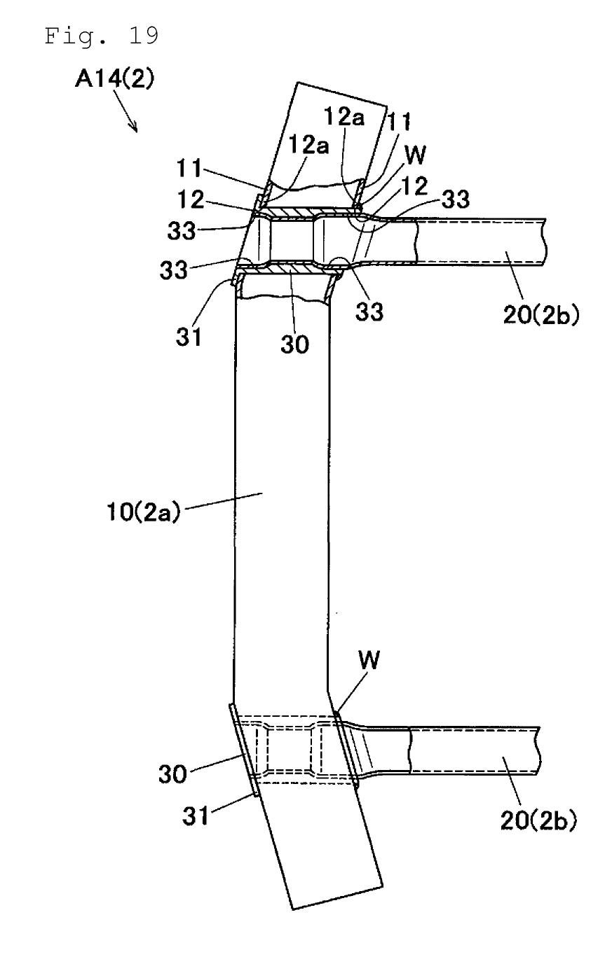

FIG. 19 is a view showing Embodiment 14 of the present invention. In this figure, “2” denotes a front bumper or a rear bumper for automobiles as the connection structure A14 for hollow members according to Embodiment 14. This bumper 2 is equipped with a bumper reinforcement 2a and two bumper stays 2b and 2b. The bumper reinforcement 2a and each of the bumper stays 2b are each made of a hollow member.

In this Embodiment 14, the first hollow member 10 as a bumper reinforcement 2a and the second hollow member 20 as a bumper stay 2b are connected with each other by the same method as the hollow member connection method explained in the abovementioned Embodiment 1. Thus, the connection structure of the connection structure A14 (i.e. bumper 2) is the same as the connection structure of the connection structure A1.

In the abovementioned Embodiments 1 to 14, an electromagnetic forming method is used as a method for expanding the peripheral wall portion 22 of the second hollow member 20, but in the present invention, for example, an expanding method of Embodiment 15 shown in FIGS. 20 to 22B can be used. The explanation of the method is as follows.

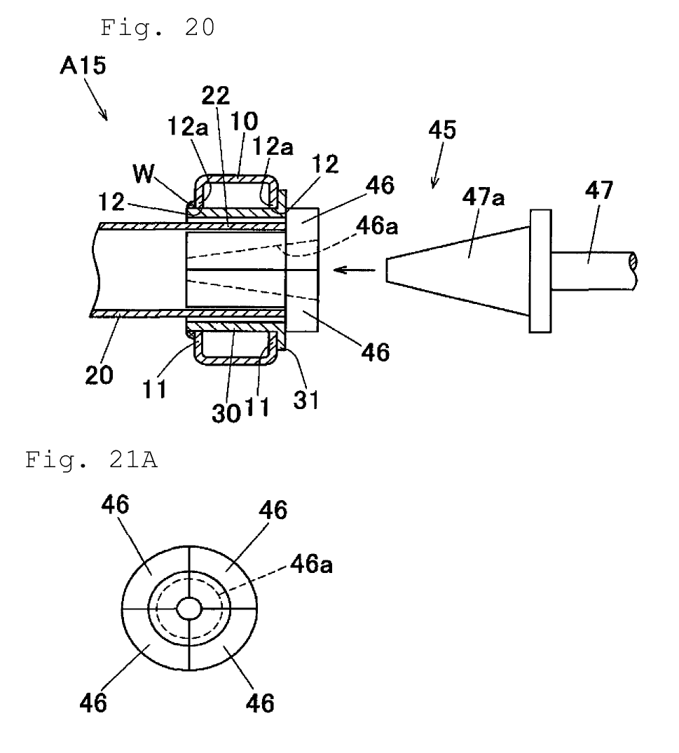

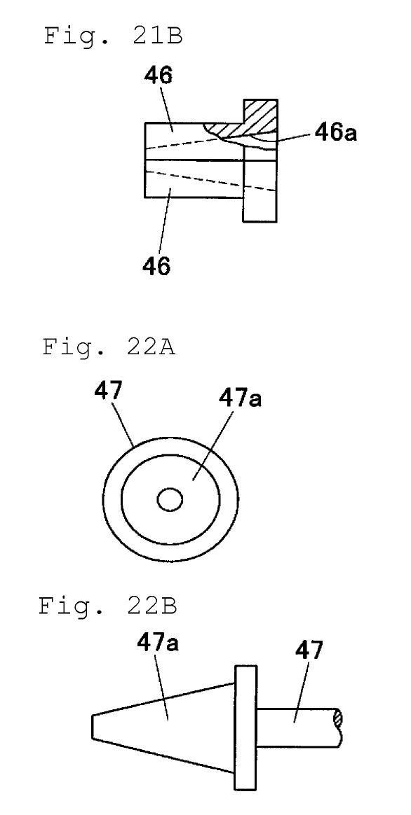

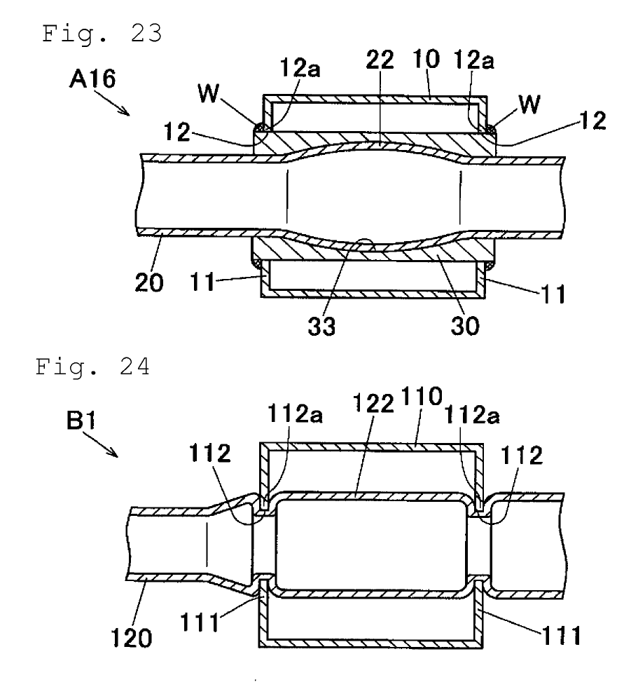

The expanding method is a method using the so-called split mold type expand punch. The expanding device 45 used in this method, as shown in FIGS. 21A to 22B, has four metallic opening claws 46, 46, 46, and 46 and a mandrel 47 for opening the opening claws. An expanded portion 47a radially outwardly expanded in a tapered shape is formed at an end portion of the mandrel 47. The expanded portion 47a is formed into a circular truncated cone shape.

In this expanding method, as shown in FIG. 20, four opening claws 46, 46, 46 and 46 are inserted into the inside of the peripheral wall portion 22 of the inserted portion of the second hollow member 20 inserted into the sleeve 30 with the opening claws combined. Next, the expanded portion 47a of the end portion of the mandrel 47 is forcibly pushed into the tapered hole 46a at the center portion of the opening claws to move the opening claws 46, 46, 46 and 46 outwardly, so that the peripheral wall portion 22 of the second hollow member 20 is expanded. With this step, the peripheral wall portion 22 is pressed against and fixed to the inner peripheral surface of the sleeve 30.

In the present invention, the aforementioned expanding method can be used for producing the connection structures A1 to A14 of the abovementioned Embodiments 1 to 14.

Although some embodiments of the present invention have been explained, the present invention is not limited to those embodiments and allows various modification thereof.

For example, the connection structure of the connection structure for hollow members according to the present invention can be a connection structure in which two or more of the connection structures of the connection structures A1 to A15 of the abovementioned Embodiments 1 to 15 are combined.

In the present invention, the cross-section of the first hollow member 10 can be a quadrilateral shape, or any other shape, such as, e.g., a circular shape, an elliptical shape, or a polygonal shape.

In the present invention, the cross-section of the second hollow member 20 can be a quadrilateral shape, or any other shape, such as, e.g., a circular shape, an elliptical shape, or a polygonal shape.

Furthermore, the connecting method for connecting hollow members according to the present invention is not limited to the cases for manufacturing automobile ladder frames 1 or bumpers 2, but can also be used to manufacture other members, such as, e.g., a main frame, a sub frame, a seat frame, a steering support beam, a muffler, or a propeller shaft for automobiles, and also can be used for manufacturing other automobile parts.

### Examples

Next, Examples and Comparative Examples of the present invention will be explained. It should be noted, however, that the present invention is not limited to any one of the Examples.

With respect to three connection structures A16, B1, and B2 shown in FIGS. 23 to 25, a static destructive test and an endurance test were performed. The results are shown in Table 1. In this Table, “F1” denotes a proportional limit load and F2 denotes a maximum load (see FIG. 6).

TABLE 1

| | Static | | | |
|---|---|---|---|---|
| | destructive test | | Endurance test | |
| | F1 | F2 | Endurable times | |
| Example 1 | 35 kN | 55 kN | =10⁷ | times |
| Comparative Example 1 | 25 kN | 50 kN | 4.7 × 10⁵ | times*¹ |
| Comparative Example 2 | 20 kN | 41 kN | 3.2 × 10⁵ | times*² |

(Note *¹: cracks were generated at 4.7 × 10⁵ times *²: cracks were generated at 3.2 × 10⁵ times)

The connection structure of each connection structural member was as follows.

Example 1: the connection structure shown in FIG. 23 (A16)

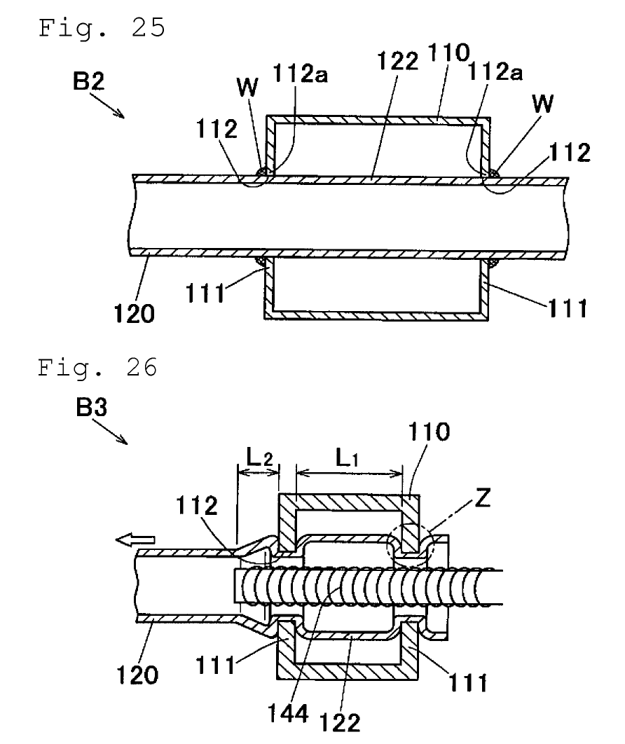

Comparative Example 1: the connection structure shown in FIG. 24 (B1)

Comparative Example 2: the connection structure shown in FIG. 25 (B2)

In the connection structure A16 of Embodiment 1, the cross-section of the first hollow member 10 was quadrilateral. The cross-section of the insertion hole 12 was circular. The cross-section of the second hollow member 20 was circular. The sleeve 30 was cylindrical. A single concave portion 33 extending along the entire circumference thereof was formed at the axial intermediate portion of the inner peripheral surface of the sleeve 30. The cross-section of the concave portion 33 was arc shaped. The sleeve 30 had no flange portion. Both the end portions of the sleeve 30 were welded to the peripheral edge portions 12a of each of the insertion holes 12 along the entire circumference thereof in a state in which the sleeve 30 was inserted in both the insertion holes 12 and 12 of the first hollow member 10, so that the sleeve 30 was fixed to the first hollow member 10. Furthermore, the peripheral wall portion 22 of the inserted portion of the second hollow member 20 inserted into the sleeve 30 was expanded using an electromagnetic forming method, so that the peripheral wall portion 22 was pressed against and fixed to the inner peripheral surface of the sleeve 30 with the peripheral wall portion 22 axially engaged with the concave portion 30. The electromagnetic forming was performed under the following condition: E=7 kJ.

The connection structure B1 of Comparative Example 1 was the same as the conventional connection structure B3 shown in FIG. 26. The electromagnetic forming was performed under the following condition: E=7 kJ.

In the connection structure B2 of Comparative Example 2, the second hollow member 120 was inserted into both the insertion holes 112 and 112 of the first hollow member 110 without intervening a sleeve. In this state, the second hollow member 120 was welded to the peripheral edge portion 112a of each insertion hole 112 along the entire circumference thereof, so that the second hollow member 120 was directly connected to the first hollow member 110.

In each of the connection structures, the material and the cross-sectional size of the first hollow member 10 and 110 and the second hollow member 20 and 120 were as follows.

The material of the first hollow member 10 and 110: A6061-T6

The material of the second hollow member 20 and 120: A6061-T6

The cross-section size of the first hollow member 10 and 110: 100×100×thickness 2 mm

The cross-section size of the second hollow member 20 and 120: f50×thickness 2 mm

As shown in Table 1, in Embodiment 1, the proportional limit load F1 and the maximum load F2 were larger than those of Comparative Examples 1 and 2, and therefore, the extraction load was larger. Furthermore, in Embodiment 1, the endurance times were larger than those of the Comparative Example 1 and 2, and therefore, the durability was excellent.

In Comparative Example 1, cracks were generated at 4.7×10⁵ endurance times.

In Comparative Example 2, crack were generated at 3.2×10⁵ endurance times. Furthermore, the second hollow member 120 was directly welded to the peripheral edge portion 112a of each insertion hole 112. Therefore, there is a problem that strength deterioration may occur in the second hollow member 120 due to heat strain or heat influence.

This application claims priority to Japanese Patent Application No. 2006-43594 filed on Feb. 21, 2006, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### INDUSTRIAL APPLICABILITY

The present invention can be applied to a connection structure for hollow members used as various frames, such as, e.g., a main frame, a sub frame, a ladder frame, a seat frame, a steering support beam, bumper, a muffler, and a propeller shaft for automobiles, and also can be applied to a connection method for such hollow members.

1. A connection structure for connecting a first hollow member and a second hollow member,
wherein an insertion hole is formed in at least one of a pair of opposed wall portions of the first hollow member,
wherein a sleeve for preventing biting of a peripheral edge portion of the insertion hole into an outer peripheral surface of the second hollow member is fixed to the first hollow member with the sleeve inserted in the insertion hole, and
wherein a peripheral wall portion of an inserted portion of the second hollow member inserted in the sleeve is expanded with the second hollow member inserted in the sleeve, so that the peripheral wall portion of the inserted portion of the second hollow member is pressed against and fixed to an inner peripheral surface of the sleeve.

2. The connection structure for hollow members as recited in claim 1,
wherein the sleeve is provided with a concave portion at the inner peripheral surface of the sleeve, and
wherein the peripheral wall portion of the inserted portion of the second hollow member is pressed against and fixed to the inner peripheral surface of the sleeve with the peripheral wall portion of the inserted portion engaged with the concave portion.

3. The connection structure for hollow members as recited in claim 2,
wherein a plurality of the concave portions are provided on the inner peripheral surface of the sleeve in a circumferentially arranged manner, and
wherein the peripheral wall portion of the inserted portion of the second hollow member is pressed against and fixed to the inner peripheral surface of the sleeve in a state in which the peripheral wall portion of the inserted portion is circumferentially engaged with the concave portions.

4. The connection structure for hollow members as recited in claim 2 or 3,
wherein a plurality of the concave portions are provided on the inner peripheral surface of the sleeve in an axially arranged manner, and
wherein the peripheral wall portion of the inserted portion of the second hollow member is pressed against and fixed to the inner peripheral surface of the sleeve in a state in which the peripheral wall portion of the inserted portion is axially engaged with the concave portions.

5. The connection structure for hollow members as recited in claim 1,
wherein a radially outwardly protruded flange portion is integrally provided at an end portion of the sleeve, and
wherein the sleeve is fixed to the first hollow member in a state in which the sleeve is inserted in the insertion hole and the flange is in contact with an outer surface or an inner surface of the first hollow member in the vicinity of the insertion hole.

6. The connection structure for hollow members as recited in claim 1,
wherein the insertion hole is formed in each of the pair of opposed wall portions of the first hollow member, and
wherein the sleeve is fixed to the first hollow member with the sleeve inserted in both the insertion holes.

7. The connection structure for hollow members as recited in claim 1,
wherein the first hollow member and the second follow member are a first frame constituent member and a second frame constituent member constituting an automobile frame, respectively.

8. The connection structure for hollow members as recited in claim 1,
wherein the first hollow member and the second follow member are a bumper reinforcement and a bumper stay constituting an automobile bumper, respectively.

9. A method for connecting a first hollow member and a second hollow member,
wherein an insertion hole is formed in at least one of a pair of opposed wall portions of the first hollow member,
the method comprising:
a sleeve fixing step for fixing a sleeve for preventing biting of a peripheral edge portion of the insertion hole into an outer peripheral surface of the second hollow member with the sleeve inserted in the insertion hole; and
an expansion step for expanding a peripheral wall portion of an inserted portion of the second hollow member inserted in the sleeve after inserting the second hollow member in the sleeve so that the peripheral wall portion of the inserted portion of the second hollow member is pressed against and fixed to an inner peripheral surface of the sleeve.

10. The method for connecting hollow members as recited in claim 9,
wherein a concave portion is provided on the inner peripheral surface of the sleeve, and
wherein, at the expansion step, the peripheral wall portion of the inserted portion of the second hollow member is expanded so that the peripheral wall portion of the inserted portion of the second hollow member is pressed against and fixed to the inner peripheral surface of the sleeve with the peripheral wall portion of the inserted portion engaged with the concave portion.

11. The method for connecting hollow members as recited in claim 10,
wherein a plurality of the concave portions are provided on the inner peripheral surface of the sleeve in a circumferentially arranged manner, and
wherein, at the expansion step, the peripheral wall portion of the inserted portion of the second hollow member is expanded so that the peripheral wall portion of the inserted portion of the second hollow member is pressed against and fixed to the inner peripheral surface of the sleeve in a state in which the peripheral wall portion of the inserted portion is circumferentially engaged with the concave portions.

12. The method for connecting hollow members as recited in claim 10 or 11,
wherein a plurality of the concave portions are provided on the inner peripheral surface of the sleeve in an axially arranged manner, and
wherein, at the expansion step, the peripheral wall portion of the inserted portion of the second hollow member is expanded so that the peripheral wall portion of the inserted portion of the second hollow member is pressed against and fixed to the inner peripheral surface of the sleeve in a state in which the peripheral wall portion of the inserted portion is axially engaged with the concave portions.

13. The method for connecting hollow members as recited in claim 9,
wherein a radially outwardly protruded flange portion is integrally provided at an end portion of the sleeve, and
wherein, at the sleeve fixing step, the sleeve is fixed to the first hollow member in a state in which the sleeve is inserted in the insertion hole and the flange portion is in contact with an outer surface or an inner surface of the first hollow member in the vicinity of the insertion hole.

14. The method for connecting hollow members as recited in claim 9,
wherein the insertion hole is formed in each of the pair of opposed wall portions of the first hollow member, and
wherein, at the sleeve fixing step, the sleeve is fixed to the first hollow member with the sleeve inserted in both the insertion holes.

15. The method for connecting hollow members as recited in claim 9,
wherein, at the expansion step, the peripheral wall portion of the inserted portion of the second hollow member is expanded by an electromagnetic forming method, a hydraulic bulge forming method, or a rubber bulge forming method.

16. The method for connecting hollow members as recited in claim 9,
wherein, at the expansion step, the peripheral wall portion of the inserted portion of the second hollow member is expanded by an expand method using a plurality of opening claws to be inserted into an inside of the peripheral wall portion of the inserted portion of the second hollow member and a mandrel for opening the plurality of opening claws.

17. The method for connecting hollow members as recited in claim 9,
wherein the first hollow member and the second follow member are a first frame constituent member and a second frame constituent member constituting an automobile frame, respectively.

18. The method for connecting hollow members as recited in claim 9,
wherein the first hollow member and the second follow member are a bumper reinforcement and a bumper stay constituting an automobile bumper, respectively.

19. An automobile frame in which a first frame constituent member of a hollow member and a second frame constituent member of a hollow member are connected with each other,
wherein the first frame constituent member and the second frame constituent member are connected as the first hollow member and the second hollow member, respectively, by the connection method for hollow members as recited in claim 9.

20. An automobile bumper in which a bumper reinforcement of a hollow member and a bumper stay of a hollow member are connected with each other,
wherein the bumper reinforcement and the bumper stay are connected as the first hollow member and the second hollow member, respectively, by the connection method for hollow members as recited in claim 9.

21. A method for producing an automobile frame in which a first frame constituent member of a hollow member and a second frame constituent member of a hollow member are connected with each other,
wherein the first frame constituent member and the second frame constituent member are connected as the first hollow member and the second hollow member, respectively, by the connection method for hollow members as recited in claim 9.

22. A method for producing an automobile bumper in which a bumper reinforcement of a hollow member and a bumper stay of a hollow member are connected with each other,
wherein the bumper reinforcement and the bumper stay are connected as the first hollow member and the second hollow member, respectively, by the connection method for hollow members as recited in claim 9.
